(19) United States
(12) Patent Application Publication
(10) Pub. No.: US 2024/0062063 A1
(43) Pub. Date: Feb. 22, 2024

(54) COMPRESSION AND DECOMPRESSION FOR NEURAL NETWORKS

(71) Applicant: Arm Limited, Cambridge (GB)

(72) Inventors: Tomas Fredrik EDSÖ, Lund (SE); Rajanarayana Priyanka MARIGI, Lund (SE)

(21) Appl. No.: 17/820,077

(22) Filed: Aug. 16, 2022

(51) Int. Cl. G06N 3/08

(52) U.S. Cl. CPC G06N 3/082

(57) ABSTRACT

Data processing systems, methods, and storage medium for implementing convolutional processes are provided. The data processing system includes a convolution engine and a set of weight decoders including a first weight decoder and a second weight decoder that implement a first decompression function and a second decompression function respectively. A weight decoder selection module for selecting a weight decoder from the set of weight decoders is provided. The data processing system, receives a compressed set of weight values, selects a weight decoder using the weight decoder selection module, and processes the compressed set of weight values using the selected weight decoder to obtain an uncompressed set of weight values. The uncompressed set of weight values are provided to the convolution engine. A corresponding data processing system, method, and storage medium for generating the compressed set of weight values is also provided.

### BACKGROUND OF THE INVENTION

### Field of the Invention

The present disclosure relates to methods and apparatus for managing data processing. In particular, but not exclusively, the present disclosure relates to managing data processing in a machine learning context.

### Description of the Related Technology

Processors used to implement neural networks, such as neural processing units (NPUs), central processing units (CPUs), graphical processing units (GPUs), digital signal processors (DSPs), and coprocessors, have processing circuitry, which is configured, to perform convolution operations. These convolution operations may include obtaining an input feature map and a set of one or more weight values and convolving the input feature map and weight values to obtain an output feature map. In some cases, the weight values may be included as part of a kernel, represented as a n-dimensional matrix of weight values, which is convolved with the input feature map, represented as an n-dimensional matrix of input values. Using a kernel may involve overlaying the kernel on the input feature map, performing elementwise multiplication of the weight values in the kernel with corresponding values in the input feature map, accumulating the result, shifting the kernel along the input feature map by a predetermined offset and repeating the process.

The processor used to perform the convolution operations may comprise on board memory for caching data such as data representing the input feature maps and output feature maps. The memory provided in the processors may not be sufficient for storing all data needed to implement a neural network or multiple convolution operations and so these processors may also access external memory when executing convolution operations. For example, the processor's onboard memory may be used to store input feature maps and output feature maps, and weight values may be stored on external memory and streamed to the processor as needed.

When storing data externally to the processor, said data may be compressed so as to reduce the amount of data having to be sent through interfaces between computing components, and to reduce the amount of storage used to store the data in the external memory.

### SUMMARY

According to a first aspect of the present disclosure there is provided a data processing system comprising: a convolution engine for implementing one or more layers of a neural network, the convolution engine being configured to receive an uncompressed set of weight values and an input feature map and to perform convolution operations using the uncompressed set of weight values and the input feature map to produce an output feature map; a set of weight decoders comprising: a first weight decoder configured to decompress a compressed set of weight values using a first decompression function to obtain the uncompressed set of weight values; and a second weight decoder configured to decompress the compressed set of weight values using a second decompression function to obtain the uncompressed set of weight values; a weight decoder selection module for selecting a weight decoder from the set of weight decoders, wherein the data processing system is configured to: obtain data representing the compressed set of weight values; select a weight decoder from the set of weight decoders using the weight decoder selection module; process the data representing the compressed set of weight values using the selected weight decoder to obtain the uncompressed set of weight values; and provide the set of uncompressed weight values to the convolution engine.

According to a second aspect of the present disclosure there is provided A computer-implemented method comprising: providing a set of weight decoders comprising: first weight decoder configured to decompress a compressed set of weight values using a first decompression function to obtain an uncompressed set of weight values; a second weight decoder configured to decompress the compressed set of weight values using a second decompression function to obtain the uncompressed set of weight values; obtaining data representing the compressed set of weight values; selecting a weight decoder from the set of weight decoders; processing the data representing the compressed set of weight values using the selected weight decoder to obtain the uncompressed set of weight values; and providing the uncompressed set of weight values to a convolution engine, the convolution engine being configured to implement one or more layers of a neural network by receiving the uncompressed set of weight values and an input feature map and to perform convolution operations using the uncompressed set of weight values and the input feature map to produce an output feature map.

According to a third aspect of the present disclosure there is provided A non-transitory computer-readable storage medium comprising computer-executable instructions which, when executed by one or more processor, cause the processors to: provide a set of weight decoders comprising: a first weight decoder configured to decompress a compressed set of weight values using a first decompression function to obtain an uncompressed set of weight values; a second weight decoder configured to decompress the compressed set of weight values using a second decompression function to obtain the uncompressed set of weight values; obtain data representing the compressed set of weight values; select a weight decoder from the set of weight decoders; process the data representing the compressed set of weight values using the selected weight decoder to obtain the uncompressed set of weight values; and provide the uncompressed set of weight values to a convolution engine, the convolution engine being configured to implement one or more layers of a neural network by receiving the uncompressed set of weight values and an input feature map and to perform convolution operations using the uncompressed set of weight values and the input feature map to produce an output feature map.

### BRIEF DESCRIPTION OF THE DRAWINGS

FIG. 1 is a schematic diagram of a neural processing unit in which examples of the present disclosure may be implemented.

FIG. 2 is a schematic diagram showing a data processing system according to examples.

FIG. 3 is a flow diagram showing a method according to examples.

FIG. 4 is a schematic diagram showing an example in which lookup tables are used for encoding and decoding according to examples in which there is a one to one mapping between uncompressed and compressed weight values.

FIG. 5 is a schematic diagram showing an example in which lookup tables are used for encoding and decoding according to examples in which clustering is provided in the lookup up table used in the encoder.

FIG. 6 is a schematic diagram showing an example in which lookup tables are used for encoding and decoding according to examples in which clustering is provided in the lookup up table used in the decoder.

FIG. 7 is a schematic diagram showing a non-transitory computer-readable storage medium according to examples.

FIG. 8 is a schematic diagram showing a data processing for compressing weight values for a neural network according to examples.

FIG. 9 is a flow chart showing a method implemented by the data processing system shown in FIG. 8.

FIG. 10 is a schematic diagram showing a non-transitory computer-readable storage medium comprising computer-executable instructions which when executed by a processor cause the processor to perform a method according to the examples shown in FIG. 9.

### DETAILED DESCRIPTION OF CERTAIN INVENTIVE EMBODIMENTS

Details of systems and methods according to examples will become apparent from the following description, with reference to the Figures. In this description, for the purpose of explanation, numerous specific details of certain examples are set forth. Reference in the specification to “an example” or similar language means that a particular feature, structure, or characteristic described in connection with the example is included in at least that one example, but not necessarily other examples. It should be further noted that certain examples are described schematically with certain features omitted and/or necessarily simplified for ease of explanation and understanding of the concepts underlying the examples.

Certain examples described herein relate to selecting and implementing different compression and decompression functions when handling streams of weight values which are to be used to implement layers of a neural network. In particular, the examples described herein relate to the selecting and implementing compression and/or decompression functions based on the respective characteristics of those functions, and characteristics of the neural networks for which the weight values are to be used.

Neural networks can generally be deployed on a range of computing devices with varying capabilities. For example, mobile devices comprising low powered processors and limited memory facilities can be configured to be able to execute neural networks for computer vision related tasks in order to provide augmented reality experiences to users. Powerful servers and super computers can be deployed to process large volumes of data using machine learning techniques such as those including neural networks and can thereby process said data efficiently to provide insights. In some of these devices, such as mobile devices or personal laptop computers, the amount of processing power available to perform machine learning operations is restricted by other desired characteristics of these devices such as a battery life, size, and heat management.

Implementing neural networks generally involve performing convolution operations on a per layer basis in which an input feature map is convolved with a set of weight values to produce an output feature map. Processors, such as neural processing units (NPUs), are configured with some on board memory, or a cache, which is generally sufficient for storing some of the information needed to implement the neural network. For example, an NPU may have a cache which is suitable for storing input feature map data, used as an input to a given layer of a neural network, and output feature map data, output from a given layer of the neural network. An output feature map from a given layer of a neural network may be used as an input feature map for a subsequent layer of the neural network. However, on board memory in an NPU may not be suitable for storing all information needed to implement a neural network and so data representing weight values is generally streamed into the NPU while the neural network is being implemented, in time for the neural network to use these weight values to implement a respective layer of a neural network. Typically, weight data, representing these weight values may be retrieved from external memory at the start of the layer or immediately before the start of a layer to be processed in the neural network.

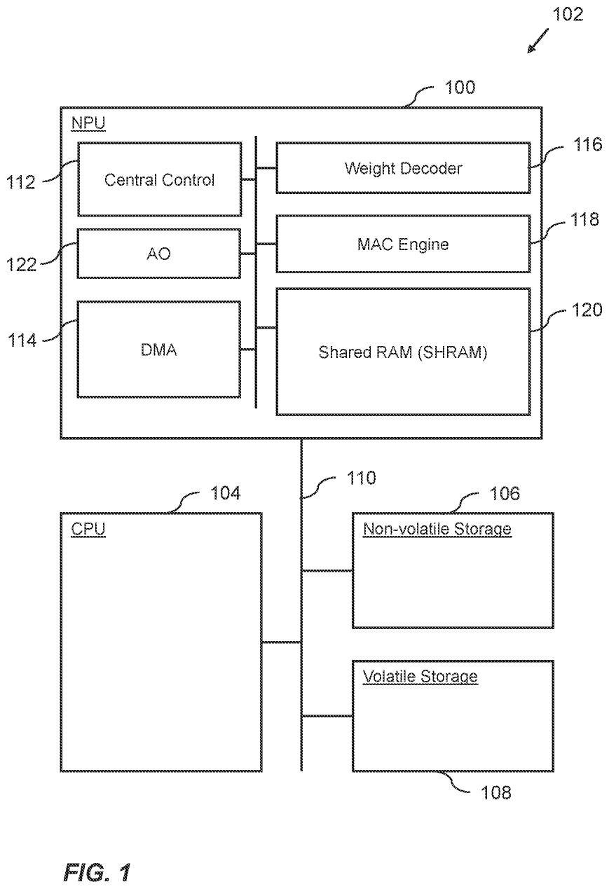

FIG. 1 shows an example of an NPU 100 included as part of a computer system 102. The computer system 102 may use the NPU 100 to perform certain machine learning tasks such as executing neural networks to run inference. The computer system 102 may also be referred to as a host system or host device. The computer system 102 may also comprise other components such as a CPU 104, or other form of general-purpose processing unit, that may be used to perform other processing functions aside from, or in addition to, machine learning tasks. Non-volatile storage 106, such as read-only memory (ROM) or other suitable non-volatile storage types, and volatile storage 108, such as random-access memory (RAM), may be provided in the computer system 102. The volatile storage 108 may include any suitable combination of one or more volatile storage types, including, but not limited to, RAM, synchronous RAM (SRAM), dynamic RAM (DRAM), synchronous DRAM (SDRAM), flash memory, and so forth. The components in the computer system 102 may be connected over a communications interface 110, such as a bus, as shown in FIG. 1.

The NPU 100 may include multiple components including a central control unit 112, that is main control unit inside the NPU 100. The central control unit 112 controls how the NPU 100 processes neural networks, maintains synchronization, and handles data dependencies. The central control unit 112 receives tasks from the external host application processor, e.g. the CPU 104, and queues and dispatches units of work to a DMA controller 114, weight decoder 116, MAC Engine 118, and others. The DMA controller 114, or Direct Memory Access controller 114, manages the memory access for the NPU 100. The DMA controller 114 may implement multiple channels for memory access into external memory 108, including a channel for input feature map data, a channel for output feature map data, and a channel for weight data. The weight channel in the DMA controller 114 may be used to transfer compressed weight values, or weight data, from external memory 108 to the weight decoder 116. The DMA controller 114 may use a read buffer to reduce the impact of bus latency from the weight decoder 116 and to enable the DMA control 114 to handle data arriving out of order.

The weight decoder 116 may be configured to read a weight stream, or a stream of weight values from the DMA controller 114. The decoder 116 may decompress and store this stream in a double-buffered register in time for the MAC Engine 118 to use it. The MAC engine 118 is an engine configured to perform Multiply ACummulate Operations (MAC) that are used for convolution, depth-wise pooling, vector products, and the max operation required for max pooling. The MAC engine 118 may include a plurality of MAC units, each MAC unit including an IFM (input feature map) unit, a dot products unit, and an adder array.

The NPU 100 includes an internal shared RAM 120, or SHRAM, that stores data. The data stored in the SHRAM 120 includes data that the NPU 100 is processing, for example, input feature map blocks, accumulators, or Lookup Table definitions which allow for data reuse. The data stored in the SHRAM 120 may additionally include data that is being, or is to be, transferred to or from the external memory 108 by the DMA control 114. The AO 122 also shown, is an activation output, that performs elementwise operations.

As briefly described above, when implementing a neural network using an NPU, the weight data for processing the whole neural network may not fit in the SHRAM 120 in the NPU 100 along with the other data to be stored in the SHRAM 120. As such, the weight data used to process a given layer is typically streamed into the NPU at, or shortly before, the start of that given layer being processed in the NPU 100. It has been found that in some cases the streaming of the weight data can be a bottleneck in the execution of neural networks. In particular, the decompression of this weight data in the weight decoder can cause a significant bottleneck in processing speed.

Certain examples described herein provide methods and systems for decoding weight values that aim to reduce the time taken to decode coded weight data while also mitigating an increase in computational expense that may otherwise occur when attempting to achieve similar processing speed increases by other methods.

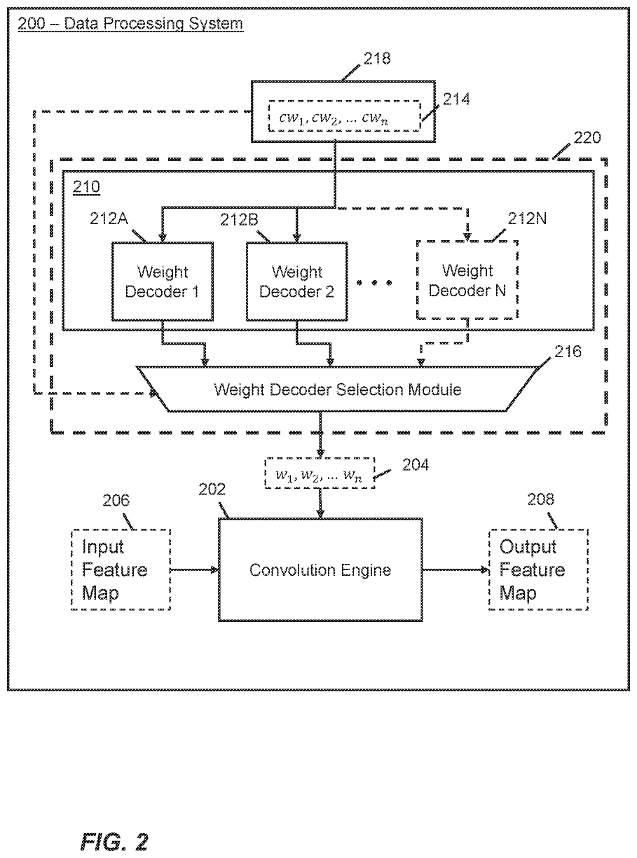

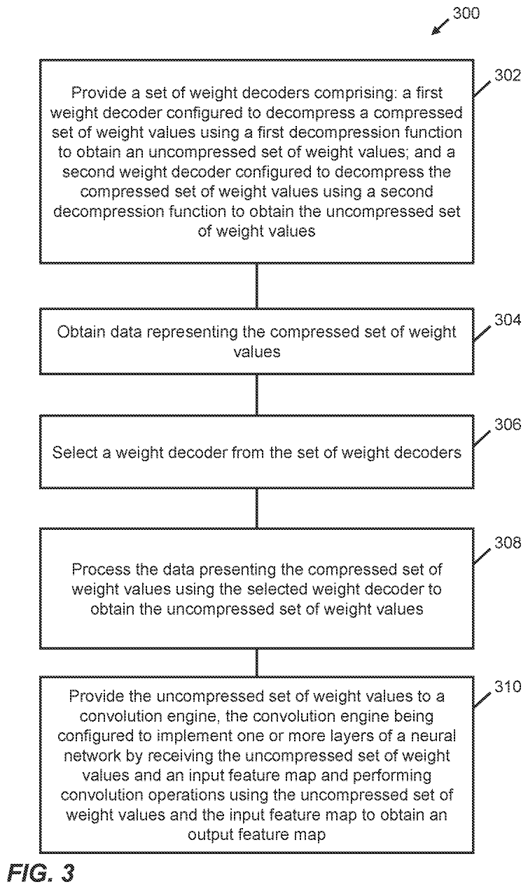

FIG. 2 shows an example of a data processing system 200 that is configured to perform a computer-implemented method 300, shown as a flow chart in FIG. 3. The data processing system 200 may be an NPU 100, similar to that shown in FIG. 1, but modified to implement the method 300. The data processing system 200 includes a convolution engine 202 for implementing one or more layers of a neural network. The convolution engine 202 is configured to receive an uncompressed set of weight values 204 and an input feature map 206 and to perform convolution operations using the uncompressed set of weight values 204 and the input feature map 206 to produce an output feature map 208. The convolution engine 202 may be implemented using dedicated processing circuitry in the data processing system 200. For example, the convolution engine may include one or more MAC engines 118 such as that shown FIG. 1. The processing circuitry used to implement the convolution engine 202 may include fixed function dedicated processing circuitry that is physically configured to perform convolution operations. In other examples, the processing circuitry may include general purpose processing circuitry, configured to perform convolution operations using program code executed by the processing circuitry. The convolution operations may include structuring the weight values 204 in one or more kernels which are convolved with the input feature map 206 according to a multiply accumulate operation.

The data processing system 200 is configured to provide 302 a set of weight decoders 210. The set of weight decoders 210 include at least a first weight decoder 212A and a second weight decoder 212B. The first weight decoder 212A is configured to decompress a compressed set of weight values 214 using a first decompression function to obtain the uncompressed set of weight values 204. The second weight decoder 212B is configured to decompress the compressed set of weight values 214 using a second decompression function to obtain the uncompressed set of weight values 204. A weight decoder selection module 216 is also provided in the data processing system 200 for selecting a weight decoder from the set of weight decoders 210. While two weight decoders 212A and 212B have been labelled in the examples of FIG. 2, the data processing system 200 may include further weight decoders 212N, shown in broken lines, that implement respective decompression functions for obtaining the uncompressed set of weight values 204 from the compressed set of weight values 214.

The set of weight decoders 210 and the weight decoder selection module 216 may be implemented in a weight decoding engine 220. In some cases, the weight decoding engine 220 may be considered to be a weight decoder in the data processing system, in which case the weight decoders 212A and 212B may be referred to as weight decoding functions.

The data processing system 200 is configured to obtain 304 data 218 representing the compressed set of weight values 214. The data 218 representing the compressed set of weight values 214 may be obtained in the form of a stream of data that is streamed to the set of weight decoders 210 from one or more external memory devices, that are outside of the data processing system 200. In other examples, the compressed set of weight values 214 are obtained from a buffer, or cache, in the data processing system 200. For example, a DMA controller, such as that shown with respect to FIG. 1, may be implemented in the data processing system 200 and may be used to provide compressed weight value data 218 to the set of weight decoders 210.

A weight decoder 212A or 212B is selected from the set of weight decoders 210 using the weight decoder selection module 216 and the data 218 representing the compressed set of weight values 214 is processed using the selected weight decoder to obtain the uncompressed set of weight values 204. Where the first weight decoder 212A is selected, the weight decoder 212A uses the first decompression function to decompress the compressed set of weight values 214, and where the second weight decoder 212B is selected, the weight decoder 212B uses the second decompression function to decompress the compressed set of weight values 214. The set of uncompressed weight values 204 are then provided to the convolution engine 202.

By allowing the selection of a weight decoder 212A or 212B, from the set of weight decoders 210, when decompressing a set of compressed set of weight values 214, it becomes possible to select a weight decoder 212A or 212B that is most suitable for the given situation, or content. In some cases, different weight decoders 212A or 212B may be more suitable in certain implementations than other weight decoders 212B or 212A. Providing the ability to select a weight decoder enables the data processing system 200 to be configured according to desired characteristics which may differ based on the implementation of the neural network and/or content of the weight values.

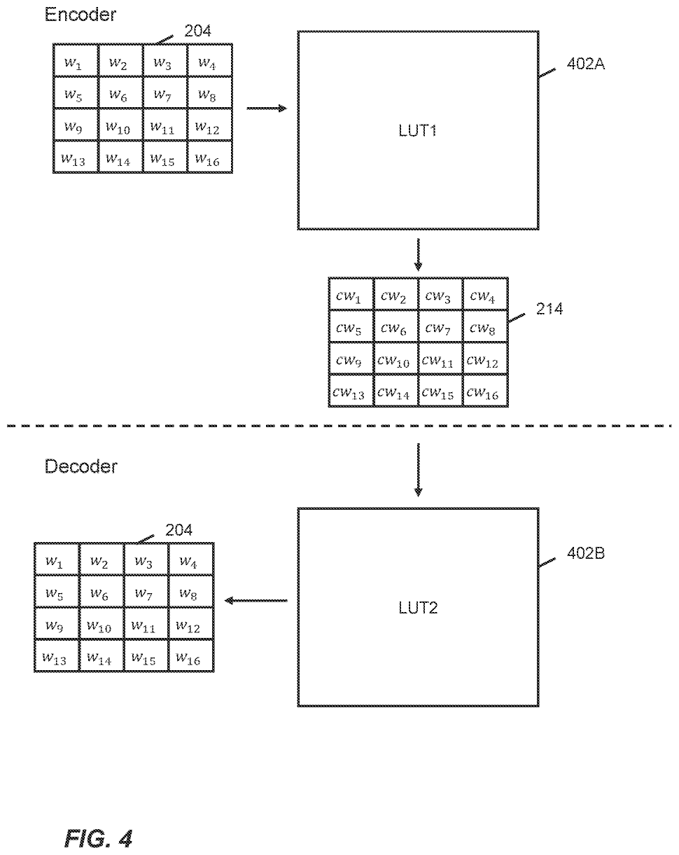

The first weight decoder 212A and the second weight decoder 212B may be different in at least one respect. For example, the first and second weight decoders 212A and 212B may include respective, different, pre-processing steps in which the data 218 representing the compressed set of weight values 214 may be processed before the first or second decompression functions are implemented to obtain the uncompressed set of weight values 204. In this case the first and second decompression functions may be substantially the same, for example implementing a similar type or class of decompression function. Alternatively, or additionally, the first decompression function and the second decompression function may be different, for example, implementing different types or classes of decompression function. Examples of differences between the first decompression function and the second decompression function will be discussed further below, with respect to FIGS. 4 to 6.

The first weight decoder 212A may be associated with a first characteristic, and the second weight decoder 212B may be associated with a second characteristic wherein the first and second characteristics are different. The characteristics may include a measure of one or more performance metrics associated with the weight decoders 212A. In one example, the first and second characteristics include respective compression ratios associated with each of the first weight decoder 212A and the second weight decoder 212B. In this case, the first weight decoder 212A may be associated with a higher compression ratio than the second weight decoder 212B. A compression ratio, in this context, relates to the ratio between the size of data representing the uncompressed set of weight values 214 and data 218 representing the compressed set of weight values 214.

Weight decoders associated with higher compression ratios can mitigate the effects of the bottle necks in data transfer that occur when transferring data between memory and processing circuitry in a data processing system 200. This is because, a given amount of data that is compressed and decompressed based on a high compression ratio is able to represent a larger number of weight values 214 than a respective amount of data that is compressed and decompressed based on a lower compression ratio. Data 218 that has been compressed according to a higher compression ratio is generally more computationally expensive to encode and decode than data 218 that has been compressed according to a lower compression ratio. That is to say, there is typically a trade-off between compression ratio and the computational expense used to compress or decompress. Computational expense in this context may refer to the amount of processing power used to implement the respective decompression function in the weight decoder.

The first and second characteristics may alternatively, or additionally, include respective first and second measures of the computational resources to be used when decompressing the compressed set of weight values 204 using the first weight decoder 212A and the second weight decoder 212B. The measure of the computational resources may include a measure of the processing power needed to implement the respective weight decoder, a measure of the power drawn by the data processing system 200 when implementing the respective weight decoder 212A or 212B, and other suitable measures of computational resources. Where the first decompression function and the second decompression function are different, the first weight decoder 212A may be more computationally expensive to implement than the second weight decoder 212B, or vice-versa. However, the second weight decoder 212B may be associated with a lower compression ratio than the first weight decoder 212A. The measure of computational resources to be used when decompressing a set of compressed weight values 214 may generally be related to a throughput rate of weight values being decompressed. That is to say, where the amount of available computational resources are constant, implementing a decompression function that requires more computational resources results in a lower throughput than a decompression function that requires less computational resources. Generally, it is not desirable to increase the computational resources in data processing systems 200, such as NPUs as they are often included low power, or handheld, computing devices such as smart mobile phones or tablet computers.

In some examples, the first characteristic may include a first composite measure of the first compression ratio and of the computational resources to be used when decompressing the compressed weight values 204 using the first weight decoder 212A. The second characteristic may include a second composite measure of the second compression ratio and of the computational resources to be used when decompressing the compressed weight values 204 using the second weight decoder 212B. Where each of the compression ratios and measures of the computational resources are represented using numerical values, the composite measures may be represented according to a weighted sum of the respective compression ratios and measure of computational resources.

It has been found that different weight decoding characteristics may be desirable depending on the particular implementation of the neural networks. In particular, it has been found that for layers of neural networks which are not fully connected layers, such as hidden, or “intermediate”, layers, the number of weight values used to perform convolution operations for such a layer is relatively small. This is due to the set weight values 204 being structured in a kernel that is passed over the input feature map 206 with MAC operations being performed at each position. Which is to say that the weight values 204 in this case are decoded once and used many times by the convolution engine 202. In this case, as few weight values are to be decoded, they can be compressed and decompressed using a weight decoder 212A associated with a high compression ratio. This is because the potential increase in the computational resources used to decompress the weight values 214 is mitigated by the relatively small number of weight values 214 that are to be decoded and as the uncompressed weight values 204 are used multiple times in the convolution engine 202.

In contrast, for fully connected layers of neural networks, a larger number of weight values 204 are generally used in the convolution operations than for non-fully connected layers. For example, each element in the input feature map 206 may be associated with a respective weight value. In this case, the increase in computational resources required to decompress the weight values 214 using the first weight decoder 212A may result in an undesirable degradation in the through put of weight values 214 to the convolution engine 202 leading to a delay in obtaining the output feature map 208. In this case, the second weight decoder 212B, implementing a less coding efficient, but also less computationally expensive, decompression function may provide a more desirable performance in terms of throughput of the weight values 204 to the convolution engine 202. The desirable performance, and whether a higher compression ratio or a lower computational expense is desired, may also be influenced by other characteristics of the data processing system 200, such as the data transfer speeds to the weight decoders.

In some examples, the weight decoder selection module 216 selects the first weight decoder 212A or the second weight decoder 212B based on a difference between the first characteristic and the second characteristic. That is to say, the selection of the first weight decoder 212A or the second weight decoder 212 may be based on their respective compression ratios, measure of computational resources to be used when implementing either of the first or second weight decoder, and/or the composite measures described above.

The weight decoder selection module 216 may be configured to process the data 218 representing the compressed set of weight values to identify which weight decoder 212A or 212B is to be selected. Generally, decompression functions used to decompress data correspond to respective compression functions used to compress the data. As such, it may not be possible to decompress data that has been compressed according to a given compression function using any decompression functions, but rather specific decompression functions may be needed. To this end, the weight decoder selection module 216 may process the data 218 to identify which weight decoder 212A or 212B is to be selected. Processing the data 218 representing the compressed set of weight values 214 may include identifying one or more characteristics of the data 218 that are indicative of a weight decoder 212A or 212B to be selected. For example, the format, structure, and or content of the data 218 may be indicative of which of the weight decoders 212A or 212B is to be used to decode the compressed set of weight values 214. In other cases, weight values for different types of neural network layers may be compressed using different compression functions. As such weight values for a particular type of neural network layer may be associated with a particular weight decoder 212A or 212B. Processing the data 218 representing the compressed weight values 214 may, in this case, include identifying a specific layer, or layer type, for which the weight values 214 are to be used.

In other examples, the data 218 representing the compressed set of weight values 214 comprises an indication of which of the set of weight decoders 210 is to be selected by the weight decoder selection module. This indication may be represented using one or more flags, an explicit description of the weight decoder to be selected, a syntax element or label applied to the data 218, or any other suitable manner in which the indication can be included in the data 218.

The weight decoder selection module 216 may additionally, or alternatively, obtain control data for controlling the decompression of the compressed set of weight values 214. For example, a controller in the data processing system, not shown in FIG. 2, may be in communication with the weight decoder selection module 216 and may signal the selection one of the set of weight decoders 210. The control data may correspond to the compressed set of weight values 214 and the weight decoder selection module 216 may select a weight decoder from the set of weight decoders 210 based on this control data. The control data may correspond to the compressed set of weight values 214 in that the control data may specify to which compressed set of weight values it is applicable.

As described above, the first weight decoder 212A and the second weight decoder 212B may implement different decompression functions. In some examples, at least one of the first decompression function or the second decompression function includes using a lookup table to decompress the compressed set of weight values. FIG. 4 shows an example of the compression and decompression of a set of weight values w 1 to w 16 using lookup tables. In the example shown a set of uncompressed weight values 204 is compressed using a lookup table 402A in an encoder. The lookup table may for example map specific weight values to values, or symbols, that require less data to be represented than the uncompressed weight values 204. For example, the uncompressed weight values 204 may include values between a particular range which includes large numbers that require a correspondingly large number of bits to represent. The lookup table 402A may map the uncompressed weight values 204 to values of a different range of values that include contrastingly small numbers that can each be represented using fewer bits.

Alternatively, the lookup table 402A may map the uncompressed set of weight values 204 to codewords, or symbols. Weight values 204 that occur more frequently may be mapped to codewords that can be represented in few bits and weight values 204 that occur less frequently may be mapped to codewords that are representable using more bits. In this way, it becomes possible to reduce the total number of bits used to represent the uncompressed weight values while maintaining the same precision in the weight values 204. The codewords, symbols, or values, to which the uncompressed weight values 204 are mapped using the lookup table 402A may be referred to as the compressed set of weight values 214.

In this case, the decoder, such as the first weight decoder 212A, may implement a corresponding lookup table 402B to the lookup table 402A implemented by the encoder. In the decoder 212A, the compressed set of weight values 214 are mapped to the uncompressed weight values 204. In the example shown in FIG. 4 there is a one-to-one correspondence between the uncompressed weight values 204 and the compressed weight values 214 using the lookup tables 402A and 402B. Where each potential uncompressed weight value 204 is mapped to a respective compressed weight value 214 the lookup table 402B may include an entry for each weight value. Where the number of available weight values is large, the lookup table 402B may be large and as such may take longer to search than a smaller lookup table.

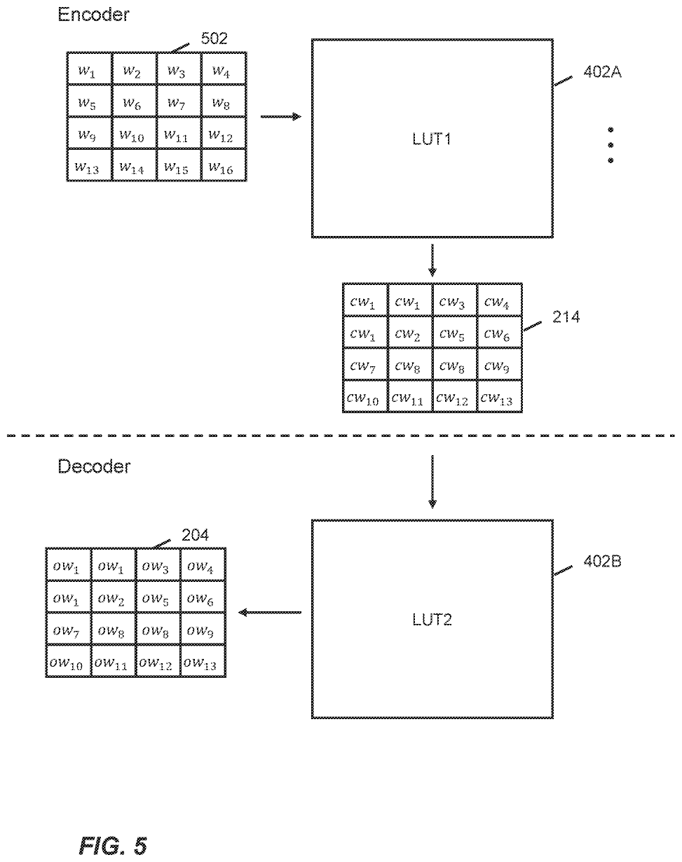

FIG. 5 shows an example in which a first uncompressed set of weight values 502 are represented in a first weight value space and the compressed set of weight values 214 are represented in a second, smaller weight value space. In this example, the uncompressed weight values 502 are mapped to a reduced set of compressed weight values 214. The lookup table 402A may group two or more of the uncompressed weight values 204 that are similar in value to a single compressed weight value 214. This is shown in FIG. 5 in which the weight values w₁, w₂, w₅ have all been mapped to a single compressed weight value cw₁. This process may also be referred to as binning, categorizing, or clustering, the uncompressed weight values 204 when obtaining the compressed weight values 214.

When implementing the encoder lookup table 402A in this manner, the lookup table 402B in the weight decoder may be smaller than the lookup table 402A in the encoder as there are fewer indices, or compressed weight values 214, to be mapped to the output values, or uncompressed weight values 204. This is because there are fewer unique compressed weight values 214 compared to the uncompressed the weight values 502. The compressed set of weight values 214 are mapped by the lookup table 402B to uncompressed weight values 204, in this case labeled as uncompressed output weight values 204, owₙ. There is a trade off in this case in that the precision of the uncompressed weight values 204, provided to the convolution engine, is reduced as compared to the original uncompressed weight values 502 that are compressed.

In this case, the lookup tables 402A and 402B used may be selected based on the content of the weight values. Which is to say that depending on the actual values taken by the uncompressed set of weight values 204 a different lookup table may be used which provides a desired performance when encoding and decoding those weight values 204.

By allowing some of the compressed weight values 214 to be repeated in the set of compressed weight values 214 it becomes possible to configure the lookup table 402A such that compressed weight values 214 that are more frequently coded may be represented using fewer bits than compressed weight values 214 that are less frequently coded. The compression ratio in this case may also be greater than the compression ratio according to the example of FIG. 4. Further, if additional compression operations are applied to the compressed weight values 214 output from the lookup table 402A, repetition may increase the coding efficiency when applying operations such as arithmetic or variable length coding.

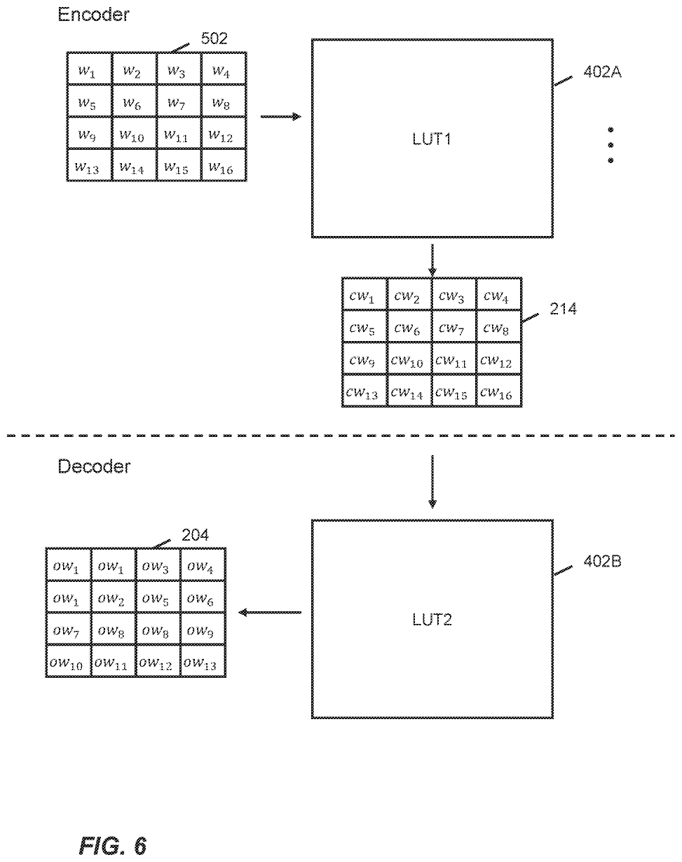

In another example, shown in FIG. 6, the weight values cw₁ to cw₁₆, in the compressed set of weight values 214 are represented in the first weight value space, and the weight values owₙ, in the uncompressed weight values 204 output from the decoder implemented lookup table 402B, are represented in the second, smaller, weight value space. Which is to say that the precision of the weight values in the output uncompressed set of weight values 204 may be reduced compared to the original uncompressed set of weight value 502. This is enabled by implementing a lookup table 402B which groups two or more compressed weight values cw₁, cw₂, cw₅ to a single uncompressed weight value ow₁. This in turn results in a smaller lookup table which is thereby quicker to search and identify mapped weight values. In this example, it becomes possible to provide a single set of compressed weight values 214 that are decodable using multiple weight decoders that implement different lookup tables 402B some of which may provide a higher precision and others which provide a lower precision, that dependent on the different arrangements and groupings of indices provided by the lookup tables.

In some cases, the lookup tables 402A and 402B may provide unique mappings between some of the weight values in the first weight value space to some weight values in the second weight value space, and may group others of the weight values in the first weight value space when mapped to weight values in the second weight value space. In this way it becomes possible to increase the precision and/or accuracy provided when decoding a subset of the output uncompressed set of weight values 204 and a reduced precision, but also a reduced complexity of decoding, for a different subset of the output uncompressed set of weight values 204. Weight values which are more important for a given neural network implementation or which are coded more frequently may be treated differently to weight values that more infrequently coded, or are less important, for implementing a given neural network.

As described above, the coding efficiency and the computational resources used to compress and decompress using lookup tables 402A and 402B may be dependent on the size of lookup tables 402A and 402B, the codewords, values, or symbols to which the weight vales are mapped, and the amount of binning performed when grouping weight values. As such, the first weight decoder 212A and the second weight decoder 212B may both implement lookup tables in which the lookup tables implemented by the first weight decoder 212A and the second weight decoder 212B differ in at least one respect, such that they have at least one characteristic that differs between the first and second weight decoders 212A and 212B.

In some examples, such as where the two weight decoders 212A and 212B both implement lookup tables, the two weight decoders 212A and 212B may include some common lookup table elements. For example, the lookup table implemented by the first weight decoder may be divisible into two sub lookup tables each corresponding to a different range of compressed weight values 214. The lookup table implemented by the second weight decoder may be divisible into two sub lookup tables each corresponding to a different range of compressed weight values and one of the sub lookup tables in the second weight decoder may correspond to one of the sub lookup tables in the first weight decoder. In this way, the second weight decoder 212B and the first weight decoder 212A may process some of the compressed set of weight values 214 the same, and may process others of the compressed set of weight values 214 differently, for example, according to a different grouping, binning, or compression ratio.

The first weight decoder 212A and the second weight decoder 212B may implement different types of decompression functions. For example, the first weight decoder 212A may implement a lookup table, while the second weight decoder 212B may implement an arithmetic decoding engine. Arithmetic coding is a form of entropy encoding that provides lossless data compression. Compression ratios achieved by arithmetic coding may be relatively high but also use substantial computational resources to encode and decode as compared to the use of lookup tables.

At least one of the first weight decoder 212A and the second weight decoder 212B may implement a plurality of decompression functions. For example, at least one of the weight decoders may include first arithmetic decoding and then using a lookup table 402B to obtain the uncompressed set of weight values 204 from the arithmetic decoded weight values.

The weight decoder selection module 216 may perform a selection of a weight decoder from the set of weight decoders 210 for each layer that is being processed by the convolution engine 202. As discussed above, each layer of a neural network being implemented may have different numbers of weight values that are to be used based on the structure, and function of the layer, wherein in fully connected layers use a large number of individual weight values and non-fully connected layers, or hidden layers, use few weight values. For fully connected layers a weight decoder that provides a high through put but a lower compression ratio may be selected. For non-fully connected layers, or layers that use few weight values, a weight decoder that provides a higher compression ratio, but a lower throughput, may be selected. In this way, the trade-offs between decoders can be balanced against the content to be used in the convolution engine 202 to increase the speed and efficiency of performance.

In the example shown in FIG. 2, the weight decoder selection module 216 is positioned at an output of the set of weight decoders 210. This may be the case where the weight decoders are implemented using fixed function hardware. In this case, each of the weight decoders may be processing the data 218 and the weight decoder selection module 216 selects which weight decoder the uncompressed weight values 204 will be selected from. As described above with respect to FIGS. 4 to 6, in some cases only specific weight decoders are able to decompress the compressed weight values 214. In other cases, different weight decoders may validly decompress the compressed set of weight values 214, though the uncompressed weight values 204 determined from that process may have a different precision, or accuracy.

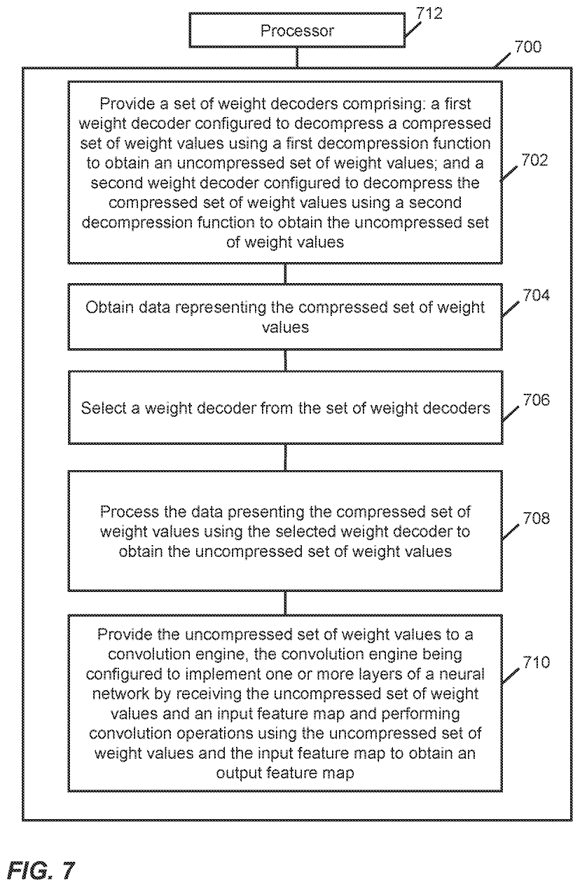

FIG. 7 shows a non-transitory computer-readable storage medium 700 including a set of computer-executable instructions 702 to 710 that, when executed by a processor 712, cause the processor to perform a method 300. The instructions include an instruction to provide 702 a set of weight decoders 210 including first and second weight decoders 212A and 212B that implement respective decompression functions. Data 218 representing the compressed set of weight values 214 is obtained 704 and a weight decoder 212A or 212B is selected 706 from the set of weight decoders 210.

The data 218 is processed 708 using the selected weight decoder to obtain the uncompressed set of weight values 204. The uncompressed set of weight values 204 are then provided to a convolution engine 202 that is configured to implement one or more layers of a neural network using the uncompressed set of weight values 204 and an input feature map.

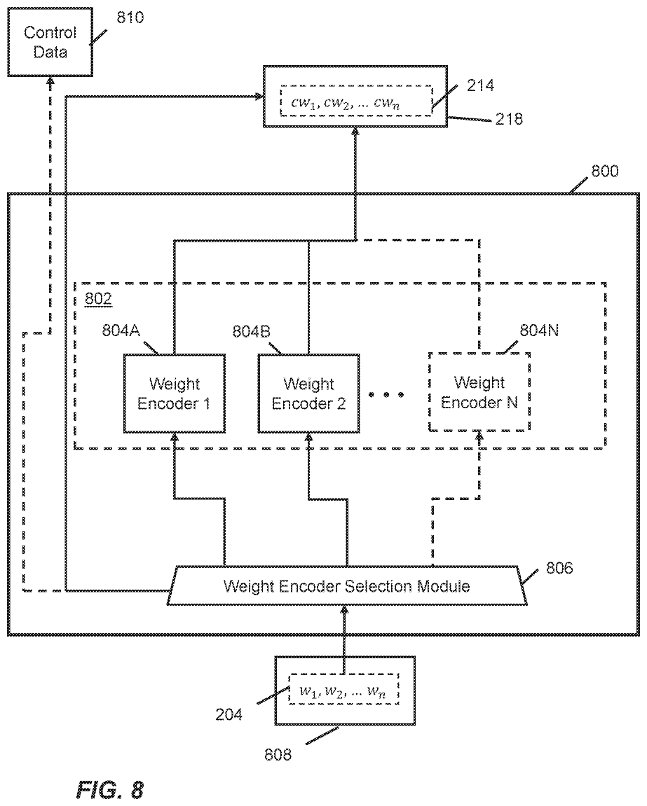

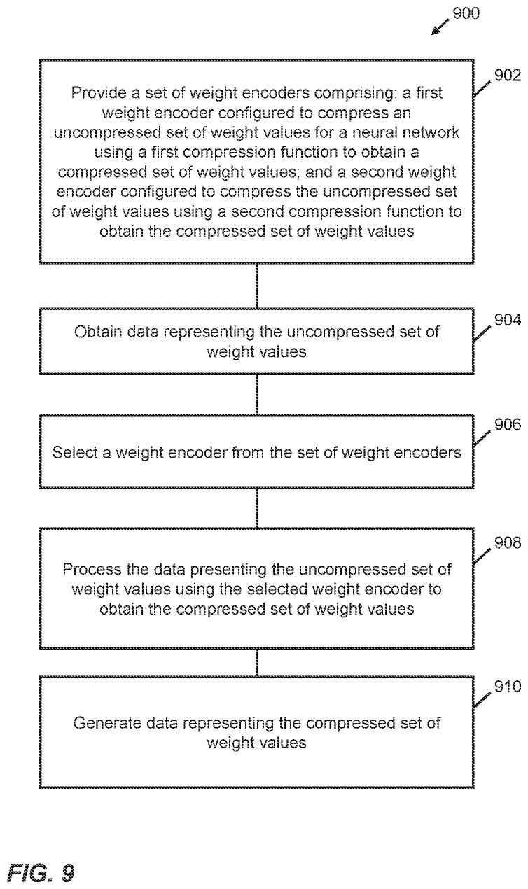

FIG. 8 shows a further data processing system 800 that implements an encoding engine, configured to perform a method 900 shown in a flow chart in FIG. 9. The encoding engine provides 902 a set of weight encoders 802, including a first weight encoder 804A and a second weight encoder 804B. The first weight encoder 804A is configured to compress an uncompressed set of weight values 204 for a neural network using a first compression function. The second weight encoder 804B is a configured to compress the uncompressed set of weight values 204 using a second compression function. The encoding engine also includes a weight encoder selection module 806 that is configured to select a weight encoder 804A or 804B from the set of weight encoders 802. The method 900 implemented by the encoding engine includes obtaining 904 data 808 representing the uncompressed set of weight values 204. Obtaining 904 the data 808 may include receiving the data 808 from the output of a compiler that compiles computer program code for implementing one or more layers of a neural network.

A weight encoder 804A or 804B is selected 906 from the set of weight encoders 802 by the weight encoder selection module 806. The data 808 representing the uncompressed set of weight values 204 is then processed 908 by the selected weight encoder to obtain the compressed set of weight values 214. The weight encoder engine 800 generates data 218 representing the compressed set of weight values 214.

By selecting the weight encoder to be used in compressing the uncompressed set of weight values 204 it becomes possible to select a weight encoder that provides a desired characteristic. For example, a desired complexity, which is related to the computational resources required to compress the uncompressed set of weight values 204, a compression ratio, and/or a precision of the weight values at the point at which they are to be processed in the neural network.

The encoding engine may include an indication of the selected weight encoder when generating the data 218 representing the compressed set of weight values 214. For example, the weight encoder selection module 806 may provide an indication of the selected weight encoder to be included in the data 218. Alternatively, or additionally, the encoding engine may generate control data 810 for controlling the decompression of the compressed set of weight values 214 in the data processing system 200. In some cases, the indication of the weight encoder that was selected may also be indicative of a weight decoder 212A or 212B that is to be selected by the data processing system 200.

In some cases, the weight encoder selection module 806 may receive an indication of which weight encoder 804A or 804B is to be selected. For example, when a neural network is created and the values are initiated a compiler, or a user, may determine based on the characteristics of the network and/or the specific layers of the neural network, which weight encoder 804A or 804B is to be selected. Alternatively, the weight encoder selection module 806 may process the data 808 representing the uncompressed set of weight values 204 to determine which of the weight encoders 804A and 804B are to be selected. Processing the data 808 in this context may include determining an architecture of the neural network for which the weight values 204 are to be used, determining whether the weight values 204 are to be used for a fully connected or non-fully connected layer of the neural network, and/or determining a characteristic of the specific weight values 204 for example, a weight value range, average or commonly occurring weight values, and/or a bit depth required to represent the weight values 204.

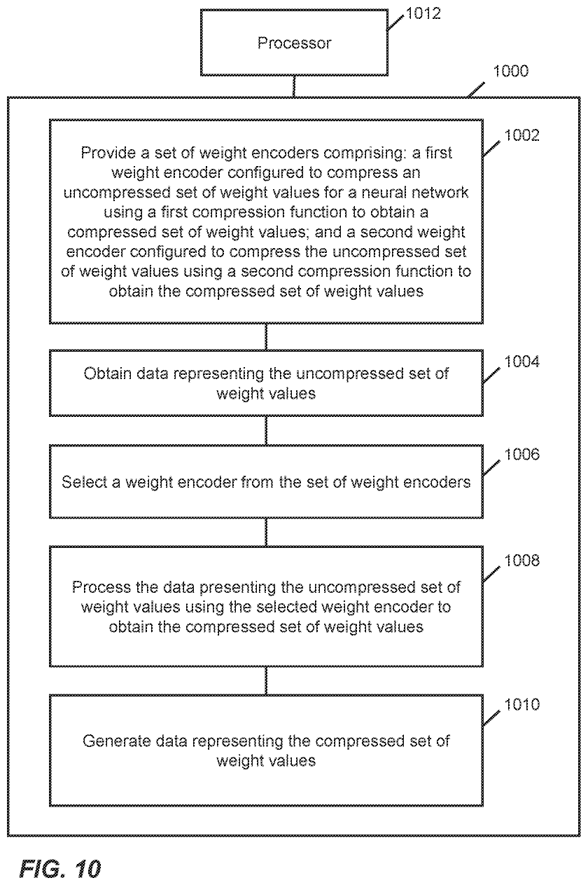

FIG. 10 shows a non-transitory computer-readable storage medium 1000 comprising computer-executable instructions 1002 to 1010 that, when executed by a processor 1012, cause the processor 1012 to perform a method according to the example described with respect to FIG. 9.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims. For example, while the selection of weight decoders and weight encoders has been described as operating on a per layer basis, they may also be selected for multiple layers, for a whole neural network, or for sub-layer groups of weight values. The examples described above generally refer to a selection between two weight decoders 212A and 212B and two weight encoders 704A and 704, however, the skilled person will appreciate that more than two of each of the weight decoders 212A and 212B and weight encoders 704A and 704B may be provided. The description with respect to the difference between the first and second weight decoders and first and second weight encoders may also apply to further weight encoders and decoders, wherein each encoder and decoder has at least one characteristic that differs to the other encoders and decoders.

### Numbered Clauses

The following numbered clauses describe various embodiments of the present disclosure.

1. A data processing system comprising:
a convolution engine for implementing one or more layers of a neural network, the convolution engine being configured to receive an uncompressed set of weight values and an input feature map and to perform convolution operations using the uncompressed set of weight values and the input feature map to produce an output feature map;
a set of weight decoders comprising:
   a first weight decoder configured to decompress a compressed set of weight values using a first decompression function to obtain the uncompressed set of weight values; and
   a second weight decoder configured to decompress the compressed set of weight values using a second decompression function to obtain the uncompressed set of weight values;
a weight decoder selection module for selecting a weight decoder from the set of weight decoders,
wherein the data processing system is configured to:
   obtain data representing the compressed set of weight values;
   select a weight decoder from the set of weight decoders using the weight decoder selection module;
   process the data representing the compressed set of weight values using the selected weight decoder to obtain the uncompressed set of weight values; and
   provide the set of uncompressed weight values to the convolution engine.

2. The data processing system of clause 1, wherein the first weight decoder and the second weight decoder are different in at least one respect.

3. The data processing system of clause 2, wherein the first weight decoder is associated with a first characteristic, the second weight decoder is associated with a second characteristic, and the first characteristic is different to the second characteristic.

4. The data processing system of clause 3, wherein the first characteristic includes a first compression ratio and the second characteristic includes a second compression ratio, and the first compression ratio is different to the second compression ratio.

5. The data processing system of clause 3, wherein the first characteristic includes a first measure of computational resources to be used when decompressing the compressed set of weight values using the first weight decoder and the second characteristic includes a second measure of computational resources to be used when decompressing the compressed set of weight values using the second weight decoder.

6. The data processing system of clause 3, wherein the first characteristic comprises a composite measure of a first compression ratio associated with the first weight decoder and of computational resources to be used when decompressing the compressed set of weight values using the first weight decoder and the second characteristic comprises a composite measure of a second compression ratio associated with the second weight decoder and of computational resources to be used when decompressing the compressed set of weight values using the second weight decoder.

7. The data processing system of clause 3, wherein the weight decoder selection module selects one of the first weight decoder or the second weight decoder based on a difference between the first characteristic and the second characteristics.

8. The data processing system of clause 1, wherein selecting a weight decoder from the set of weight decoders comprises processing the data representing the compressed set of weight values to identify which weight decoder is to be selected.

9. The data processing system of clause 8, wherein the data representing the compressed set of weight values comprises an indication of which of the set of weight decoders is to be selected.

10. The data processing system of clause 1, wherein the data processing system is configured to obtain control data corresponding to the compressed set of weight values, and wherein selecting a weight decoder from the set of weight decoders comprises selecting a weight decoder from the set of weight decoders based on the control data.

11. The data processing system of clause 1, wherein at least one of the first decompression function and the second decompression function comprises using a lookup table to decompress the compressed set of weight values.

12. The data processing system of clause 11, wherein the weight values in the compressed set of weight values are represented in a first weight value space, and the weight values in the uncompressed set of weight values are represented in a second, smaller, weight value space.

13. A computer-implemented method comprising:
providing a set of weight decoders comprising:
   first weight decoder configured to decompress a compressed set of weight values using a first decompression function to obtain an uncompressed set of weight values;
   a second weight decoder configured to decompress the compressed set of weight values using a second decompression function to obtain the uncompressed set of weight values;
obtaining data representing the compressed set of weight values;
selecting a weight decoder from the set of weight decoders;
processing the data representing the compressed set of weight values using the selected weight decoder to obtain the uncompressed set of weight values; and
providing the uncompressed set of weight values to a convolution engine, the convolution engine being configured to implement one or more layers of a neural network by receiving the uncompressed set of weight values and an input feature map and to perform convolution operations using the uncompressed set of weight values and the input feature map to produce an output feature map.

14. The computer-implemented method of clause 13, wherein the first weight decoder is associated with a first characteristic, the second weight decoder is associated with a second characteristic, and the second characteristic is different to the first characteristic.

15. The computer-implemented method of clause 14, wherein the first characteristic includes a first compression ratio, the second characteristic includes a second compression ratio, and the first compression ratio is different to the second compression ratio.

16. The computer-implemented method of clause 14, wherein the first characteristic includes a first measure of computational resources to be used when decompressing the compressed set of weight values using the first weight decoder and the second characteristic includes a second measure of computational resources to be used when decompressing the compressed set of weight values using the second weight decoder.

17. The computer-implemented method of clause 14, wherein the first characteristic comprises a composite measure of a first compression ratio associated with the first weight decoder and of computational resources to be used when decompressing the compressed set of weight values using the first weight decoder and the second characteristic comprises a composite measure of a second compression ratio associated with the second weight decoder and of computational resources to be used when decompressing the compressed set of weight values using the second weight decoder.

18. The computer-implemented method of clause 13, wherein the selecting a weight decoder from the set of weight decoders comprises processing the data representing the compressed set of weight values to identify which weight decoder is to be selected.

19. The computer-implemented method of clause 18, wherein the data representing the compressed set of weight values comprises an indication of which of the weight decoders is to be selected.

20. The computer-implemented method of clause 13, wherein the method comprises obtaining control data corresponding to the compressed set of weight values, and wherein selecting a weight decoder is dependent on the control data.

21. The computer-implemented method of clause 13, wherein at least one of the first decompression function and the second decompression function comprises using a lookup table to decompress the compressed set of weight values.

22. A non-transitory computer-readable storage medium comprising computer-executable instructions which, when executed by one or more processor, cause the processors to:
provide a set of weight decoders comprising:
   a first weight decoder configured to decompress a compressed set of weight values using a first decompression function to obtain an uncompressed set of weight values;
   a second weight decoder configured to decompress the compressed set of weight values using a second decompression function to obtain the uncompressed set of weight values;
obtain data representing the compressed set of weight values;
select a weight decoder from the set of weight decoders;
process the data representing the compressed set of weight values using the selected weight decoder to obtain the uncompressed set of weight values; and provide the uncompressed set of weight values to a convolution engine, the convolution engine being configured to implement one or more layers of a neural network by receiving the uncompressed set of weight values and an input feature map and to perform convolution operations using the uncompressed set of weight values and the input feature map to produce an output feature map.

23. A data processing comprising:
a set of weight encoders comprising:
   a first weight encoder configured to compress an uncompressed set of weight values for a neural network using a first compression function to obtain a compressed set of weight values;
   a second weight encoder configured to compress the uncompressed set of weight values using a second compression function to obtain the compressed set of weight values; and
a weight encoder selection module for selecting a weight encoder from the set of weight encoders,
wherein the data processing system is configured to:
   obtain data representing the uncompressed set of weight values;
   select a weight encoder from the set of weight encoders using the weight encoder selection module;
   process the data representing the uncompressed set of weight values using the selected weight encoder to obtain the compressed set of weight values; and
   generate data representing the compressed set of weight values.

24. The data processing system of clause 23, wherein the generating the data representing the compressed set of weight values includes generating an indication of the selected weight encoder and including the indication in the data representing the compressed set of weight values.

25. The data processing system of clause 23, wherein the data processing system further configured to generate control data for control a process for decompressing the compressed set of weight values, the control data including an indication of the selected weight encoder.

26. The data processing system of clause 23, wherein the data processing system is configured to process the data representing the uncompressed set of weight values to identify which of the weight encoders is to be selected.

27. The data processing system of clause 26, wherein the selecting a weight encoder is based on a characteristic of the uncompressed set of weight values.

28. The data processing system of clause 27, wherein the characteristic of the uncompressed set of weight values includes any one or more of:
a type of neural network for which the uncompressed set of weight values are to be used;
a type of layer in which the uncompressed set of weight values are to be used; and
a characteristic of numerical values represented by the uncompressed set of weight values.

29. A computer implemented method comprising:
providing a set of weight encoders comprising:
   a first weight encoder configured to compress an uncompressed set of weight values using a first compression function to obtain a compressed set of weight values; and
   a second weight encoder configured to compress the uncompressed set of weight values using a second compression function to obtain the compressed set of weight values;
obtaining data representing the uncompressed set of weight values';
selecting a weight encoder from the set of weight encoders;
processing the data representing the uncompressed set of weight values using the selected weight encoder to obtain the compressed set of weight values; and
generating data representing the compressed set of weight values.

30. A non-transitory computer-readable storage medium comprising computer-executable instructions which, when executed by a processor, cause the processor to:
provide a set of weight encoders comprising:
   a first weight encoder configured to compress an uncompressed set of weight values using a first compression function to obtain a compressed set of weight values; and
   a second weight encoder configured to compress the uncompressed set of weight values using a second compression function to obtain the compressed set of weight values;
obtain data representing the uncompressed set of weight values';
select a weight encoder from the set of weight encoders;
process the data representing the uncompressed set of weight values using the selected weight encoder to obtain the compressed set of weight values; and
generate data representing the compressed set of weight values.

What is claimed is:

1. A data processing system comprising:
a convolution engine for implementing one or more layers of a neural network, the convolution engine being configured to receive an uncompressed set of weight values and an input feature map and to perform convolution operations using the uncompressed set of weight values and the input feature map to produce an output feature map;
a set of weight decoders comprising:
a first weight decoder configured to decompress a compressed set of weight values using a first decompression function to obtain the uncompressed set of weight values;
a second weight decoder configured to decompress the compressed set of weight values using a second decompression function to obtain the uncompressed set of weight values; and
a weight decoder selection module for selecting a weight decoder from the set of weight decoders,
wherein the data processing system is configured to:
obtain data representing the compressed set of weight values;
select a weight decoder from the set of weight decoders using the weight decoder selection module;
process the data representing the compressed set of weight values using the selected weight decoder to obtain the uncompressed set of weight values; and
provide the set of uncompressed weight values to the convolution engine.

2. The data processing system of claim 1, wherein the first weight decoder and the second weight decoder are different in at least one respect.

3. The data processing system of claim 2, wherein the first weight decoder is associated with a first characteristic, the second weight decoder is associated with a second characteristic, and the first characteristic is different to the second characteristic.

4. The data processing system of claim 3, wherein the first characteristic includes a first compression ratio and the second characteristic includes a second compression ratio, and the first compression ratio is different to the second compression ratio.

5. The data processing system of claim 3, wherein the first characteristic includes a first measure of computational resources to be used when decompressing the compressed set of weight values using the first weight decoder and the second characteristic includes a second measure of computational resources to be used when decompressing the compressed set of weight values using the second weight decoder.

6. The data processing system of claim 3, wherein the first characteristic comprises a composite measure of a first compression ratio associated with the first weight decoder and of computational resources to be used when decompressing the compressed set of weight values using the first weight decoder and the second characteristic comprises a composite measure of a second compression ratio associated with the second weight decoder and of computational resources to be used when decompressing the compressed set of weight values using the second weight decoder.

7. The data processing system of claim 3, wherein the weight decoder selection module selects one of the first weight decoder or the second weight decoder based on a difference between the first characteristic and the second characteristics.

8. The data processing system of claim 1, wherein selecting a weight decoder from the set of weight decoders comprises processing the data representing the compressed set of weight values to identify which weight decoder is to be selected.

9. The data processing system of claim 8, wherein the data representing the compressed set of weight values comprises an indication of which of the set of weight decoders is to be selected.

10. The data processing system of claim 1, wherein the data processing system is configured to obtain control data corresponding to the compressed set of weight values, and wherein selecting a weight decoder from the set of weight decoders comprises selecting a weight decoder from the set of weight decoders based on the control data.

11. The data processing system of claim 1, wherein at least one of the first decompression function and the second decompression function comprises using a lookup table to decompress the compressed set of weight values.

12. The data processing system of claim 11, wherein the weight values in the compressed set of weight values are represented in a first weight value space, and the weight values in the uncompressed set of weight values are represented in a second, smaller, weight value space.

13. A computer-implemented method comprising:
providing a set of weight decoders comprising:
a first weight decoder configured to decompress a compressed set of weight values using a first decompression function to obtain an uncompressed set of weight values;
a second weight decoder configured to decompress the compressed set of weight values using a second decompression function to obtain the uncompressed set of weight values;
obtaining data representing the compressed set of weight values;
selecting a weight decoder from the set of weight decoders;
processing the data representing the compressed set of weight values using the selected weight decoder to obtain the uncompressed set of weight values; and
providing the uncompressed set of weight values to a convolution engine, the convolution engine being configured to implement one or more layers of a neural network by receiving the uncompressed set of weight values and an input feature map and to perform convolution operations using the uncompressed set of weight values and the input feature map to produce an output feature map.

14. The computer-implemented method of claim 13, wherein the first weight decoder is associated with a first characteristic, the second weight decoder is associated with a second characteristic, and the second characteristic is different to the first characteristic.

15. The computer-implemented method of claim 14, wherein the first characteristic includes a first compression ratio, the second characteristic includes a second compression ratio, and the first compression ratio is different to the second compression ratio.

16. The computer-implemented method of claim 14, wherein the first characteristic includes a first measure of computational resources to be used when decompressing the compressed set of weight values using the first weight decoder and the second characteristic includes a second measure of computational resources to be used when decompressing the compressed set of weight values using the second weight decoder.

17. The computer-implemented method of claim 14, wherein the first characteristic comprises a composite measure of a first compression ratio associated with the first weight decoder and of computational resources to be used when decompressing the compressed set of weight values using the first weight decoder and the second characteristic comprises a composite measure of a second compression ratio associated with the second weight decoder and of computational resources to be used when decompressing the compressed set of weight values using the second weight decoder.

18. The computer-implemented method of claim 13, wherein the selecting a weight decoder from the set of weight decoders comprises processing the data representing the compressed set of weight values to identify which weight decoder is to be selected.

19. The computer-implemented method of claim 13, wherein at least one of the first decompression function and the second decompression function comprises using a lookup table to decompress the compressed set of weight values.

20. A non-transitory computer-readable storage medium comprising computer-executable instructions which, when executed by one or more processor, cause the processors to:
provide a set of weight decoders comprising:
a first weight decoder configured to decompress a compressed set of weight values using a first decompression function to obtain an uncompressed set of weight values;
a second weight decoder configured to decompress the compressed set of weight values using a second decompression function to obtain the uncompressed set of weight values;
obtain data representing the compressed set of weight values;
select a weight decoder from the set of weight decoders;
process the data representing the compressed set of weight values using the selected weight decoder to obtain the uncompressed set of weight values; and
provide the uncompressed set of weight values to a convolution engine, the convolution engine being configured to implement one or more layers of a neural network by receiving the uncompressed set of weight values and an input feature map and to perform convolution operations using the uncompressed set of weight values and the input feature map to produce an output feature map.
